(19) United States
(12) Patent Application Publication
(10) Pub. No.: US 2009/0112957 A1
(43) Pub. Date: Apr. 30, 2009

(54) System and methods for data sample decimation and display of scanning probe microscope images

(76) Inventors: Daniel Yves Abramovitch, Palo Alto, CA (US); Richard Kenton Workman, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/981,982

(22) Filed: Oct. 31, 2007

(51) Int. Cl. G06F 7/38

(52) U.S. Cl. 708/313

(57) ABSTRACT

Methods, systems and components for producing a scanning probe microscope (SPM) image. One method embodiment includes receiving sample data from a scanning probe microscope wherein said sample data comprises data sample many times per pixel of the SPM image to be displayed; selecting at least one decimation scheme from a plurality of different decimation schemes, for decimating the sample data to provide a single data value per pixel; and decimating the sample data, using the at least one selected decimation scheme. A method of decimating sample data scanned along scan lines from a surface of an object to be imaged includes at least temporarily storing multiple adjacent scan lines of the sample data prior to decimating at least a portion of the sample data; correlating adjacent samples of the sample data; and selecting a decimation scheme different from a decimation scheme previously selected to be applied to sample data within a pixel pertaining to an image to be formed from the sample data, when correlating provides results in which a value from one line of comparison is different from a value from another line of comparison by at least a predetermined value, but otherwise maintaining the previously selected decimation scheme for decimating the sample data pertaining to that pixel.

### BACKGROUND OF THE INVENTION

The scanning probe microscope (SPM) provides one of the most versatile methods of imaging nanoscale structures. Unlike the transmission electron microscope (TEM) and scanning electron microscope (SEM), an SPM is not restricted to imaging in a vacuum environment. Furthermore the SPM, and specifically the atomic force microscope (AFM) is becoming a driving technology in nanomanipulation and nanoassembly and is playing a burgeoning role in the field of molecular biology.

Quite often, the rate at which data is sampled by an SPM is far too high to display in an actual surface image, such as on a computer display or other type of display. The winnowing down of the sample data to a size that is suitable for display is referred to as “decimation”. Different methods of decimation can dramatically change the resulting dataset, sometimes causing artifacts that do not faithfully represent the property of the object being measured. Among such artifacts are aliasing, in which high-frequency components of a waveform or image are represented as low frequency components (e.g., where a high-frequency signal is erroneously visualized as a lower frequency signal), or loss of data representing small features in the data, so that the small features do not appear in the image of the decimated data that is displayed. A classic example of aliasing occurs when the sample rate and input signal violate the Nyquist sampling theorem, i.e., when a frequency component of the input signal to a sample data system is greater than half the sample rate of that system.

Further, different decimation techniques have different advantages and disadvantages, and depending upon the surface features of an object being scanned, one decimation technique, algorithm or scheme may be advantageous to use, whereas for a different object having different surface features, that same algorithm or scheme may be less advantageous to use than another different algorithm or scheme.

Accordingly, there is a continuing need for systems, methods and components that are versatile enough to process sample data according to different techniques to improve the accuracy of the images produced thereby, as the accuracy of applied techniques may vary depending upon the surface features of the object being scanned.

### BRIEF DESCRIPTION OF THE DRAWINGS

FIG. 1 is a block diagram illustrating use of a variant of a scanning force microscope, i.e., an atomic force microscope in contact mode to produce an AFM image.

FIG. 2 illustrates a raster scan pattern.

FIG. 3 illustrates many data samples that are provided per pixel.

FIG. 4 illustrates examples of numbers of samples per pixel for different scan and sample rates.

FIGS. 5A-5C illustrate negative effects that may occur when applying an averaging decimation scheme to sample data, and when applying a peak (peak detection) decimation scheme to the sample data, respectively.

FIG. 6A illustrates use of a look-ahead filtering scheme.

FIG. 6B illustrates comparison lines along which adjacent sample data may be compared according to a look-ahead filtering technique.

FIG. 7A illustrates a user interface according to an embodiment of the present invention.

FIG. 7B illustrates a pre-filtering menu display of the user interface of FIG. 7A.

FIG. 7C illustrates a decimation scheme selection menu display of the user interface of FIG. 7A.

FIG. 8 illustrates an atomic force microscope image displayed on the display of user interface 120.

FIG. 9 illustrates events that may be carried out according to a method of decimation of SPM sample data scanned from an object according to an embodiment of the present invention.

FIG. 10 illustrates events that may be carried out according to an embodiment of a method of decimating sample data scanned along scan lines on an object to be imaged.

FIG. 11 illustrates events that may be carried out according to a method of providing an atomic force microscope (AFM) image of an object according to an embodiment of the present invention.

FIG. 12 illustrates a typical computer system in accordance with an embodiment of the present invention.

### DETAILED DESCRIPTION OF THE INVENTION

Before the present systems, methods and computer readable media are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a sample” includes a plurality of such samples and reference to “the scan” includes reference to one or more scans and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The term “object” refers to that which is being scanned by the scanning probe microscope to provide data samples that characterize the object.

The term “sample” or “sampling” refers to measurements of physical quantities at distinct time instants. In this context, physical quantities are presented to transducers which convert the sensed quantity into some signal, usually a voltage or current in an electronic circuit. The sample itself is a measurement of this voltage or current at a pre-specified time. Sampling is usually accompanied by conversion of a sample to a digital signal through the use of an analog to digital converter (ADC).

The term “image” refers to the graphical visual representation of the measured properties of an object that is represented after processing the sample data. An image is not limited to a photographic image or other optical image, but includes one or more picture elements (e.g., one or more pixels). Thus, a single pixel image is possible, as well as a single line image, a short and wide image, a tall and narrow image, a nearly square image, etc. Image data is not limited to representation of surface topography of an object, as it can alternatively represent friction between a probe of an SPM and the object or a representation of deflection of the probe arm, for example when using an AFM in contact mode. In AC mode, demodulation of multiple different signals can be performed, where the multiple different signals are generated from the oscillatory deflection signal from deflection of the probe arm. Coherent demodulation can be used to demodulate a signal at different relative phases to the return signal. For example, it is commonplace to mix copies of a returned signal with two sinusoid signals that are 90 degrees out of phase with each other. This enables the separate demodulation of the amplitude and phase of the return signal relative to some reference. Furthermore, multiple harmonics of the oscillatory deflection signal can be demodulated, yielding a large number of different images that can be displayed and/or otherwise further processed.

“Post processing” as used herein, refers to processes that are performed after decimation of the sample data. Accordingly, one form of post processing the decimated sample data is displaying the sample data as an image. Another form of post processing is the storage of the decimated sample data. The sample data can be post processed to generate a force versus distance curve, for example, or a current versus distance curve. Post processing may also include any modification of the data after decimation that makes the post-processed data non-identical to the data prior to post processing, including, but not limited to offsetting the data by adding the same number to each data value, removing tilt in the data by subtracting the slope in the X- and/or Y-axis directions of the original data, applying a filter to the data such as a low-pass, high-pass, sharpen, or other image processing filter, further decimation or interpolation of the data to allow for display, etc.

The present invention provides systems, methods and components for producing a scanning probe microscope (SPM) image.

According to at least one embodiment, a method of producing a scanning probe microscope (SPM) image includes: receiving sample data from a scanning probe microscope wherein the sample data comprises data sample many times per pixel of the SPM image to be displayed; selecting at least one decimation scheme from a plurality of different decimation schemes for decimating the sample data to provide a single data value per pixel.

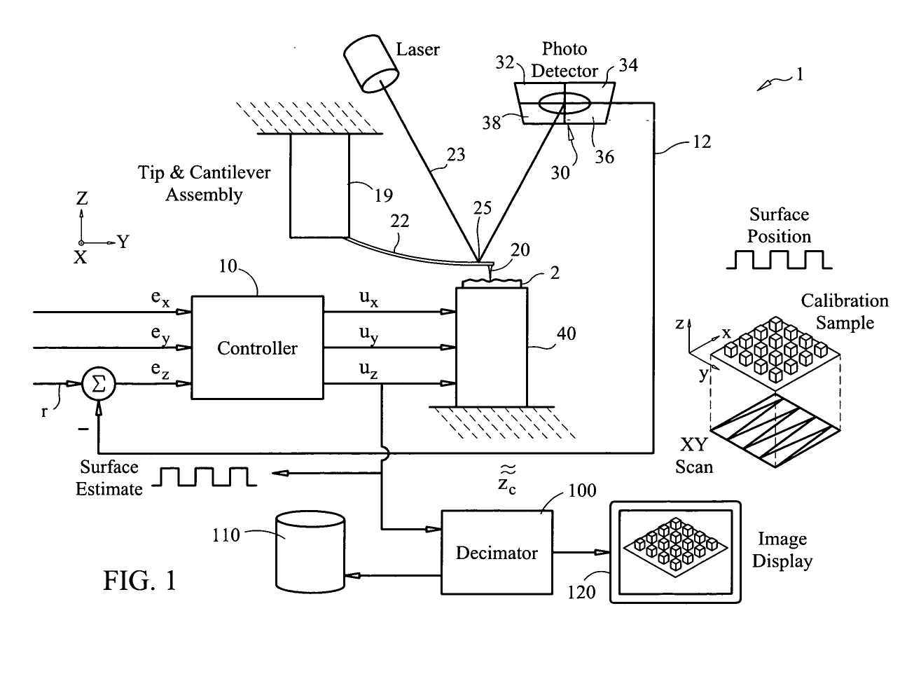

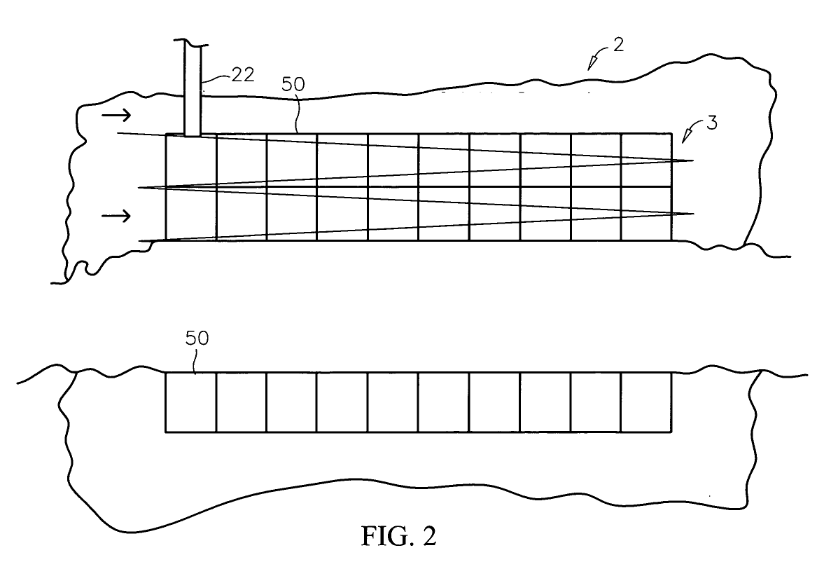

FIG. 1 is a block diagram illustrating use of a variant of a scanning probe microscope called an atomic force microscope (AFM) system 1 including a system 100 for decimating sample signals output by the AFM controller 10, storage 110 for storing the decimated signals, and optionally, all signals outputted by the AFM controller 10, and a display 120 for displaying images from the decimated signals. FIG. 1 illustrates use of the AFM in contact mode. The AFM includes a sharp probe tip 20 that may be formed on a cantilever arm 22, or on an arm having a triangular design or other design configured to flex a predetermined amount when a predetermined amount of force is applied via the tip 20, with the opposite end of the arm 22 being connected to a fixed reference point 19. The probe tip 20 is brought into close proximity to the surface of the object 2 where it is affected by the forces on the surface, some attractive and some repulsive. A scan of the surface of the object 2 (which is typically performed as an X-Y raster scan, e.g., see FIG. 2), during which time the forces on the tip 20 vary, due to changes in the attractive and repulsive forces, thereby also varying the amount of deflection force on the arm 20. Scanning may be performed by holding the object 2 in a fixed position and moving the tip 20 and arm 22 along the scan pattern, or by holding the tip 20 and arm 22 fixed and moving the object 2 under the tip 20, as illustrated in FIG. 1. In either case, the relative X-Y motion of the object 2 and the tip 20, while the tip 20 is interacting with the surface of the object 2, produces deflection of the arm 22 in the Z-direction. The deflection in the Z-direction is measured and correlated with the relative X- and Y-positions of the object 2 with respect to the tip 20. The motion of the X-, Y- and Z-axes are generated by an actuator, typically a piezoelectric or micro-electric mechanical system (MEMS) actuator 40. The surface interaction is detected by measuring a tunneling current for a scanning tunneling microscope (STM) and optically for an atomic force microscope (AFM). Other methods besides optical can be used for AFM surface interaction detection. Further, it is possible to perform open- or closed-loop control on the SPM via use of the controller 10.

One way of monitoring the deflections of arm 22 is by reflecting a laser beam 23 off of the back surface of the arm 22 at a predetermined location 25. The predetermined location 25 may be polished or otherwise provided with a mirror surface, for example. The reflected laser beam is detected by a photo detector 30. The detector 30 may be provided with four quadrants 32, 34, 36, 38 that allow both the longitudinal bending modes and the lateral torsional modes of the arm 22 to be detected. The detected bending deformations of the arm 22 are fed back through the control loop 12 as a negative feedback signal. The negative feedback signal is summed with a reference deflection r. Error signals eₓ, e_{y} and e_{z} for the three axes of motion are shown in the control loop 12. When a reference trajectory is provided in the X- and Y-directions, eₓ and e_{y} refer to the difference between this reference trajectory and the X-Y position of the object 2. For the Z-axis, the reference is often a reference deflection (for contact mode) or a reference amplitude (for Amplitude Modulated (AC) mode) and e_{z} is the difference between this reference signal and the detected signal. In the case of AC mode, the detected signal is demodulated before the comparison with the reference. The signals uₓ, u_{y}, u_{z} are signals generated by the controller 10 to drive the actuator 40. In many cases, certain axes will be run in open loop, that is, no error signal will be used in controlling the axis and the control signal driving the actuator is typically set to the reference signal. The system controller 10 controls the movements of arm 22 always forcing it back to the predetermined amount of deflection r. Thus, the controller 10, typically a proportional-integral-derivative (PID), proportional-integral (PI) or state space controller generates a control signal to actuator 40 to counter the bending moments on arm 22 to maintain the arm 22 at the predetermined reference deflection r. The control signal is also output to decimator 100, which after appropriate decimation of the signal, outputs and/or stores the decimated signal, thereby storing it in storage device 110 and/or post processes the decimated signal, wherein post processing includes, but is not limited to displaying an image of the sample surface on display 120, since the control signals required to counter the deflections mirror the surface topography of the sample. As noted above, other types of post processing of the decimated signal can be formed in addition, or alternative to, displaying an image.

Further details regarding the components, functions and use modes of atomic force microscopes can be found in Giessibl, “Advances in Atomic Force Microscopy”, Reviews of Modern Physics 75 (3), 949-983 (2003), which is incorporated herein, in its entirety, by reference thereto, as well as in other known sources. Any number of signals can be output to be decimated, including, but not limited to: the controller output signals, signals quantifying the deflection of the cantilever 22, and/or an error signal.

As noted above, to generate an AFM image, a tip 20 is scanned across a surface of an object 2, typically using a raster scan pattern 3 as illustrated in FIG. 2, for example. While the scans are usually done in a back-and-forth manner, as illustrated by the back and forth dotted lines in FIG. 2, each image is typically constructed only from signals from scans generated in a single direction only. It is not unusual to generate two images, one for each scan direction. Each cell 50 corresponds to a pixel of an image that is eventually generated from the sample data scanned from the object 2 in the location of the cell 50. As there is a one-to-one correspondence between the size of the cell 50 and the size of the pixel of the image corresponding to the area of the object 2 that that cell 50 covers, cells 50 are alternately referred to as pixels herein. Because the sample rate is typically very fast, each pixel of the scan will be sample a plurality of times.

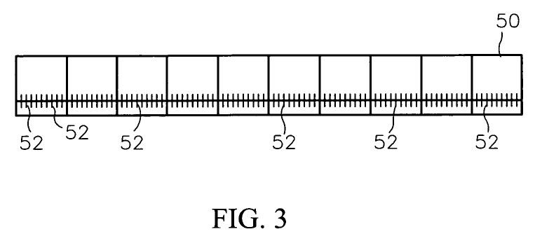

FIG. 3 illustrates a view of ten cells or pixels 50 of the raster scan of FIG. 2, illustrating samples taken in only one of the directions across which the cells 50 would be scanned. FIG. 3 shows that for each pixel 50, a plurality of samples 52 are taken during each scan. The number of actual samples taken from a pixel will vary depending upon the scan speed and sampling rate, but can be quite numerous.

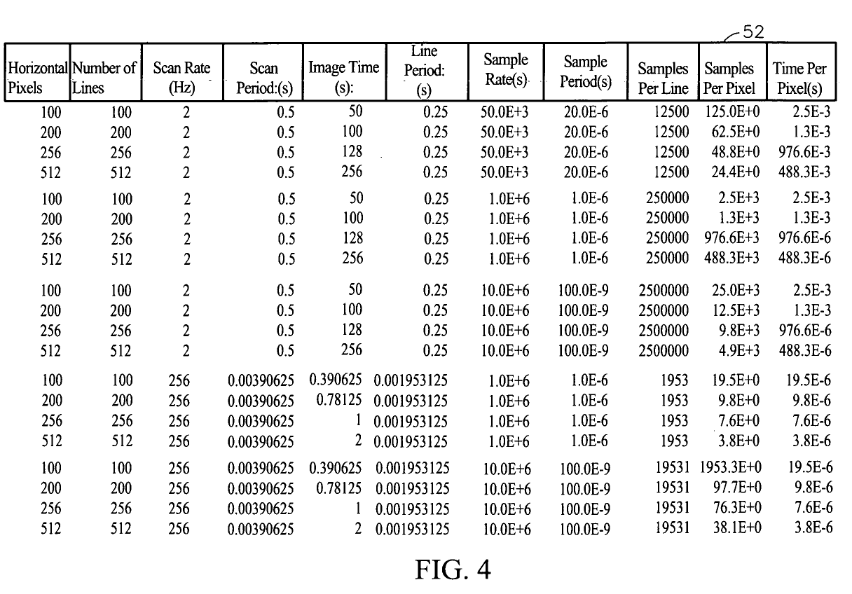

FIG. 4 illustrates examples of numbers of samples per pixel for different scan and sample rates. Even the slow sample and scan rates of current SPMs (e.g., a 2 Hz line scan with a 50 kHz sample rate) generates many samples 52 per pixel 50 (e.g., anywhere from about 24.4 to about 125 samples per pixel, depending upon the number of pixels per line, as shown). More advanced SPM systems feature higher sample rates that further compound the problem of representing all sample data on a single display. For example, sample rates may be in the range of about 1 to about 50 MHz. A 10 MHz sample rate on a 512×512 pixel image with a line scan rate of 256 Hz will result in about thirty-eight samples per pixel. Accordingly, since there are far fewer pixels available in the image to be displayed than the number of samples. Decimation reduces the amount of data to a size that can be displayed, for example on a computer monitor, or other display device, since none of these will typically have the capacity to display all of the sample data. Careful consideration is also needed for the potential artifacts that may be generated, or important data that may be omitted by various methods of decimation.

One method of reducing the number of samples to a number that can be displayed on the pixels available in the display in which the image is to be displayed is to synchronously decimate the samples, which is referred to here as simple decimation. With simple decimation, only one of the N (N being a number greater than one) samples for each pixel is selected to be displayed. Because the controller sampling rate will not always necessarily be a multiple of the pixel rate, N can be a non integer number so that decimation can be performed evenly with respect to the number of pixels. Thus, for example, decimation may be performed by selecting the 8.7^{th} sample for each pixel. In this case, the selected data point is interpolated from adjacent data points. The first order interpolation fits a line between the two closest points and then a value on that line that corresponds to the desired position of the decimated sample is selected. The sample number displayed is the same for each pixel, whether the sample number selected is according to an integer value or non-integer value.

As an example where the sample selected is an integer value, if there are ten samples per pixel, a simple decimation may select the third sample from each group of ten sequentially-ordered ten samples, so that, for each pixel, the third sample of the ten is displayed in the image. This method allows frequency domain techniques (e.g., Fast Fourier Transforms, etc.) to be applied to the resultant decimated data, but these results can also lead to aliasing if there is a component of the data with a frequency that is a harmonic of the sub-sampling rate (i.e., sampling rate of the decimated data).

Another decimation technique involves averaging the samples for each pixel. Thus, if there are ten samples for each pixel, the values of the ten samples are summed and then divided by the number of samples (in this case, ten) to provide an average sample value which is then used in the image representation of that pixel. As with simple decimation, averaging can be performed over a non-integer number of samples N. This method avoids the potential aliasing problem that is present with simple decimation, however, there is a risk of de-emphasizing the actual value of the height of a small feature within a pixel, such that a false sense of smoothness of the data results.

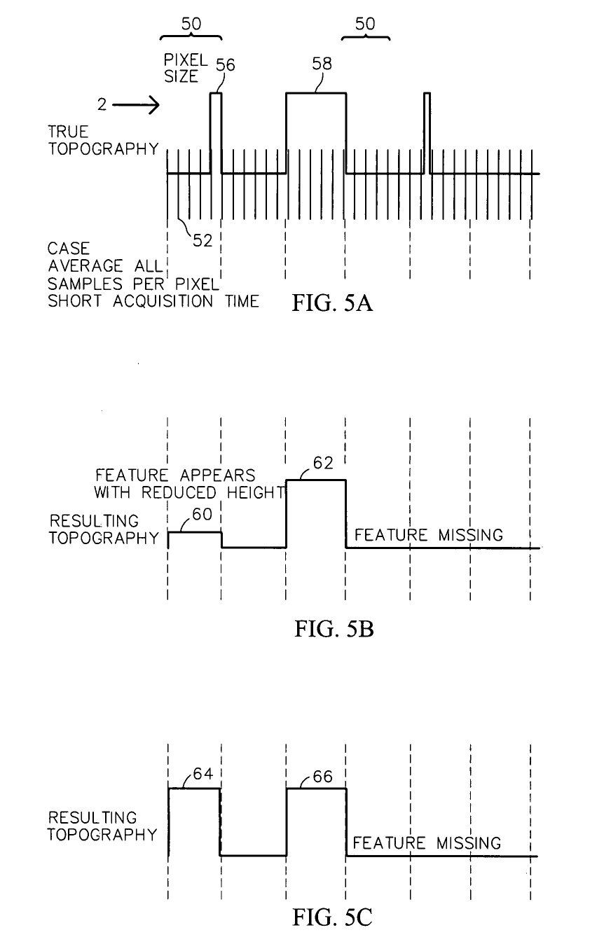

FIGS. 5A-5B illustrate an example of this potential problem with the use of averaging decimation. Looking at the line graph at FIG. 5A, the true topography of the surface of the object 2 is plotted, with the X-axis being the dimension of the object across which a scan is made, and the Y-axis showing the heights of the surface features of the object 2 along the scan line. The vertical dashed lines in FIGS. 5A-5C delineate the bounds of the pixels over which the samples are taken. It can be observed that small feature 56 has about the same height as the larger feature 58 in the actual topography. However, when the height values recorded at each sample 52 for a pixel 50 are summed and the sum is divided by the total number of samples in that pixel to provide an average value to be represented in the pixel in the AFM image, it can be observed in FIG. 5B that the average value 60 representing the smaller feature 56 has much less height that the average value 62 representing the feature 58, so that the height of the actual features 56, 58 is not accurately represented by the average decimation technique, as the smaller feature 56 is reduced disproportionately to the larger feature 58.

Another decimation method reports the highest or “peak” sample value in each pixel. A typical approach to the peak decimation method is to keep track of the minimum as well as the maximum sample value for each pixel. A drawback to this technique is that it can overemphasize smaller features relative to larger ones. Referring to FIG. 5A, when the samples 52 taken for object 2 described above are decimated by peak decimation, the height of the smaller feature 56 is accurately represented relative to the height of the larger feature 58, as shown in FIG. 5C, but the peak value 64 misrepresents the width (or length, generally a dimension normal to the height value reported, in a direction of the scan) of the smaller feature 56 relative to that of the larger feature 58, as both values 64 and 66 have the same width and falsely show both features 56 and 58 to be of about the same width.

Another decimation technique uses acquisition clock dithering to pick one out of the N samples per pixel, but the sample number of the chosen sample is varied among the pixels. This technique eliminates the potential problem of aliasing, since the decimated signal never “locks on” to any harmonic that would cause aliasing.

Optionally, pre-filtering of the sample data may be carried out prior to decimation. For example, a bandpass filter may be applied to the sample data (time domain data) to limit certain frequencies or limit the contribution of broadband noise, for example, and then one or more decimation methods may be performed on the filtered data. A bandpass filter allows signals in a particular, predetermined frequency band to pass through. A bandstop filter or a notch filter will block signals in a predetermined frequency range. A low-pass filter will pass low-frequency signals and limit high-frequency signals. Accordingly, a user might select, or a system may be preset to have, a low-pass filter to pre-filter the data to remove high-frequency noise. If there is interference or ringing at a particular frequency, the user might choose to use a notch or bandstop filter to remove this problem. A bandpass filter may be used to allow only a small subset of frequencies to pass into the image.

Pre-filtering may be particularly useful when using a peak detection method of decimation, as peak detection methods are often susceptible to broadband noise. The filter used may specify the center frequency and bandwidth, so that random noise can be reduced, but small features can still be detected.

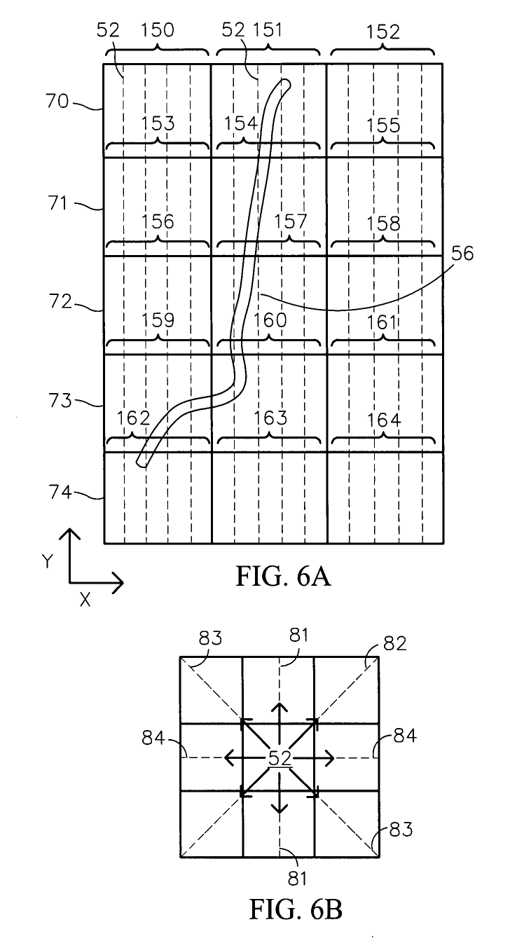

The scans provide a two-dimensional arrangement of data points. Typically the scans are performed along a fast axis, usually called the X-axis, and a slow axis, typically called the Y-axis. Because the scans provide a two-dimensional arrangement of data points (with a third dimension being the amplitudes of the signals which are indicative of the properties of the surface locations scanned, e.g., surface height/topography, friction, amplitude, phase, magnetic force, tunneling current, or other property), two-dimensional smoothing or filtering may also be performed on the data. Unless a feature is small compared with the pitch between adjacent scans, there is typically a correlation between corresponding pixels in adjacent lines of a scan when a feature of an object surface is present, where “corresponding” is defined as pixels located within a defined neighborhood of each other. In one example, corresponding pixels to a given pixel are those pixels that are within the three pixels (neighborhood) directly above the given pixel (e.g., center pixel 52 of FIG. 6B). Additionally, or alternatively, corresponding pixels may include the three pixels directly below the given pixel, and or the pixels in the same scan line of the given pixel that are located directly before and directly after the given pixel. However, this is a non-limiting example, as the neighborhood may be expanded, for example to five pixels above and/or below and/or two pixels before and after the given pixel, or even to adjacent lines of pixels. Corresponding pixels can be used in pre-processing the data to be used to generate the image. For example, FIG. 6A illustrates a feature 56 (e.g., a DNA strand, or other small, elongate feature) that is present on the surface of an object being scanned. Only a portion of the raster scan is shown, i.e., three pixels on each of five adjacent scan lines (i.e., pixels 150-152 on scan line 70, pixels 153-155 on scan line 71, pixels 156-158 on scan line 72, pixels 159-161 on scan line 73, and pixels 162-164 on scan line 74. Five samples 52 are taken for each pixel shown. Note that it is not unusual to take many more samples than five per pixel of the image, and that five samples per pixel is used for simplicity of illustration and explanation.

Referring now to the pixel 154 of scan line 71, the feature 56 appears in the third sample 52, but not in any of the other samples (sample 1, 2, 4 or 5) of pixel 154. Accordingly, if averaging decimation is being used, the resulting value for pixel 154 will be significantly reduced or smoothed, for reasons described above with regard to FIGS. 5A-5B. Accordingly, the value of pixel 154 may make it appear to a user that a feature is not even present (noise) or that something other than the DNA strand 56 is being visualized, due to the diminished nature of the signal value in that pixel. However, by using look-ahead filtering, the system can store sample data from adjacent scan lines for comparison within the current pixel. Thus, in this example, the system stores the sample data from scan lines 70-72 (at least up until pixel 157) before decimating the sample data for pixel 154. Note that scan lines 70-72 are oriented in the Y-direction of the raster scan pattern 3, while samples in the same scan line extend along the X-axis. In this way, values of samples that are adjacent the samples to be decimated (in either the X- or Y-directions, or a combination thereof, such as adjacent along a diagonal that extends in both X- and Y-directions) can be compared with the values of the samples to be decimated. Thus, in the example of FIG. 6A, a significant value (i.e., value that is attributable to a feature, not noise) is identified in the third sample 52 of pixel 154, as being apparently above a background noise level. The presence of this feature can be noted as extra information about the decimated data. Additionally, the decimation algorithm can be modified so as to emphasize the identified feature in the image. A secondary map of the features can be generated using the original decimation algorithm. Alternatively or additionally, the decimation algorithm may be modified, at least one example of which are provided below. Correlations are next looked for in adjacent samples, to help differentiate between whether the current sample 52 is a random noise signal, or whether the current sample is actually identifying a feature to be visualized in the image. Linear filtering performs comparisons with regard to each sample the same way, but non-linear or time-varying filtering can alternatively be carried out to filter different samples in different manners.

For example, when comparing the samples 52 in adjacent pixels in some X,Y-direction (i.e., samples in pixels adjacent to the pixel of the current sample, e.g., pixels bordering of pixel 154), an elevated signal will also be apparent in two of these two samples. This is a good indicator that the third sample 52 of pixel 154 represents an actual feature and not just random noise, even though the samples that are adjacent in the X-direction (i.e., horizontally-adjacent second and forth samples 52 of pixel 154) show negligible or baseline values. Based on these comparisons, the system may then automatically select a different decimation technique to determine the value of the pixel 154 for scan line 71. For example, peak decimation may be selected. FIG. 6B gives examples of averaging directions (e.g., 81, 82, 83 or 84) that may be searched. The number of directions increases with the number of samples in adjacent pixels. By considering averages of samples along a predefined direction, e.g., along direction 81, 82, 83 and/or 84, the presence or absence of a surface feature at this sample can be inferred. This can be effective in finding the values most consistent with the neighborhood of the pixel being considered. For this look-ahead filtering, wherein data samples from one or more scan lines before and/or after the current scan line are compared with a current sample in the current scan line that is being decimated, some intermediary storage of data sample is performed. Therefore there is a delay in the decimation process. For example, in FIG. 6A, at least portions of scan lines 70 and 72 are stored in addition to storing scan line 71, in order to carry out the look-ahead filtering of the samples in scan line 71 as described above. Thus the scanning process itself must be at least at scan line 72 to accomplish this look-ahead filtering and therefore the decimation of scan line 71 is delayed, i.e., not real time.

In general, when using one (or a portion of one) adjacent line on either side of the current line, the system can compare samples in at least four different directions of adjacency, as illustrated in FIG. 6B. However, the presence of multiple samples within pixels in adjacent lines will greatly increase the number of available averaging directions. Furthermore, the use of more than two adjacent lines allows for more directions of adjacency. One way of performing these comparisons is to sum the values of the adjacent samples 52 in the comparison direction and average them. This averaging process can be carried out in each of the directions. Then, by comparing the average values for each comparison direction, if the signal read by the sample of interest is random noise, then the average values for each of the comparison directions should be about the same. Alternatively, if one of the average values is more than a predetermined percentage greater than another of the average values (e.g., at least 50% greater, although this predetermined percentage may be set higher or lower), then it is likely that a feature is being identified in the same direction as the comparison direction having the greatest average value. The system then may apply a decimation technique that does not smooth the feature value in the pixel 50 of the sample 52 with which the comparisons are made. Note also, that this averaging technique is not limited to averaging across three scan lines, as more, scan lines (and thus more samples) may be included in the comparison directions and in the averaging calculations.

Alternatively, if the sample being compared with adjacent values is more than a predetermined percentage value higher than the other two samples in a first comparison direction, but is less than a second predetermined percentage value (smaller than the first predetermined percentage value) different from an adjacent sample in a second comparison direction, then it is likely that a feature is being detected in the same direction as of the second comparison direction line, and the system may apply a decimation technique that does not smooth the feature value in the pixel 50 of the sample 52 with which the comparisons are made.

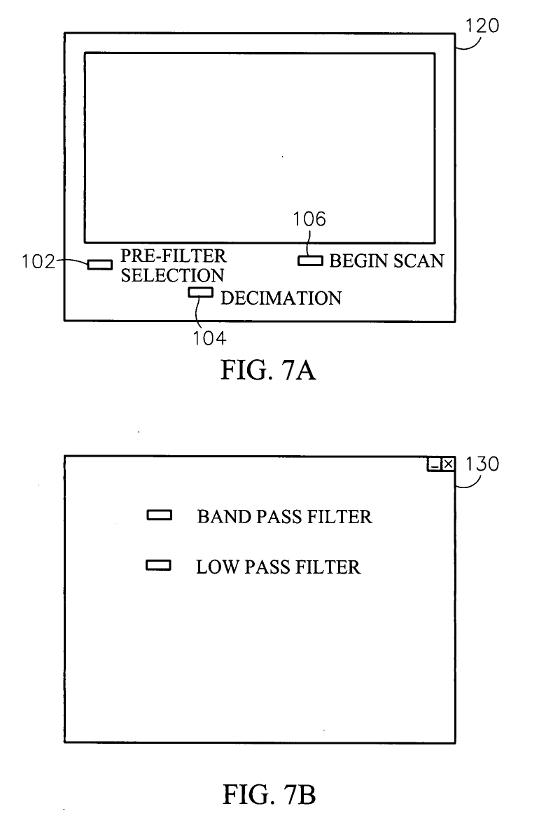

FIG. 7A illustrates a user interface 120 of the system that is configured for user selection of filtering. Prior to scanning an object 2 to obtain an SPM image of the surface thereof, a user may select a filtering scheme to be used to pre-process the sample data by pre-filtering prior to decimation. If a user chooses to apply some type of pre-filtering, a selection is made at 102 (radio button or some other selectable feature on the display of the user interface. The selection can be made by a mouse click or keyboard stroke, for example, or some other selection tool. The selection at 102 causes the menu 130 shown in FIG. 7B to be displayed. From this menu, the user can select one or more filters to be applied to the sample data for pre-filtering the sample data prior to decimating it. Combinations of filters can be implemented as a single combination filter, or alternatively, single filters can be applied serially to provide the combination pre-filtering. After selections have been made, or if the user decides not to choose any pre-filtering, the menu window 130 can be closed. If no pre-filtering is selected, the system may be provided with a default type of pre-filtering, such as a low-pass filter, for example, to eliminate high-frequency noise, or alternatively, may not perform any pre-filtering.

The system also provides with the user the ability to select one or more decimation methods to be used in decimating the sample data to display the decimated data as an SPM image. If the user does not make any selections regarding decimation, the system defaults to a predetermined, pre-programmed decimation scheme, which may be simple decimation, averaging decimation, peak decimation, or any of the various decimations schemes described herein, as well as any combination of decimation schemes. By selecting feature 104, menu 140 shown in FIG. 7C is displayed on the user interface 120. From this menu, the user can select one or more decimation schemes to be applied to the sample data. As noted previously, different decimation schemes are associated with different drawbacks. Thus, for example, a user may want to ensure that aliasing does not occurring by doing simple decimation on only a portion of the samples per pixel, while another portion is decimated by a dithering decimation scheme. This is only one example, and the user is not limited to the combination of decimation schemes to be applied, or the order in which the decimation schemes are applied.

For each decimation scheme selected, the user can set a percentage of the sample data per pixel that is to be decimated by that method and in what order. Thus, for example, the user may select “peak” decimation, 100%, in which case, the order box need not be filled in, since all sample data will be processed using peak decimation. As another example, the user may select simple, enter 50% in the percentage box for simple, and enter order no. 1 in the box on the line for simple; select peak, enter 20% for percentage on the line for peak, enter order no. 2 on the line for peak and select dithering, enter 30% for the percentage in the box on the line for dithering, and enter order no. 3 on the line for dithering. In this case, each pixel would be processed in a way that the first 50% of samples would be decimated by simple decimation, the next 20% of the samples for the pixel would be decimated by peak decimation, and the last 30% of the samples in for the pixel would be decimated using acquisition clock dithering-type decimation. Further alternatively, multiple percentages and multiple order numbers can be set for a particular type of decimation, For example, if the user wanted the first 20% of the samples to be simple decimated and the last 20% of the samples to also be simple decimated, the user would select simple, enter “20,20” in the percentage box for simple and enter “1,3” in the order box (assuming only three groupings of decimation are used in this example). If all of the order boxes are left blank, then the selected decimation techniques will be applied in a random order, but with each method being applied across a block of the number of samples per pixel corresponding to the percentage shown for that particular decimation technique. However, this random order remains the same for each pixel. Still further, if “look-ahead” filtering is selected, then the other decimation methods selected (or the default decimation method if no other decimation methods are selected) will function as the default decimation method for those samples identified, but a different decimation method may be automatically selected for any pixel in accordance with the look-ahead filtering techniques described above.

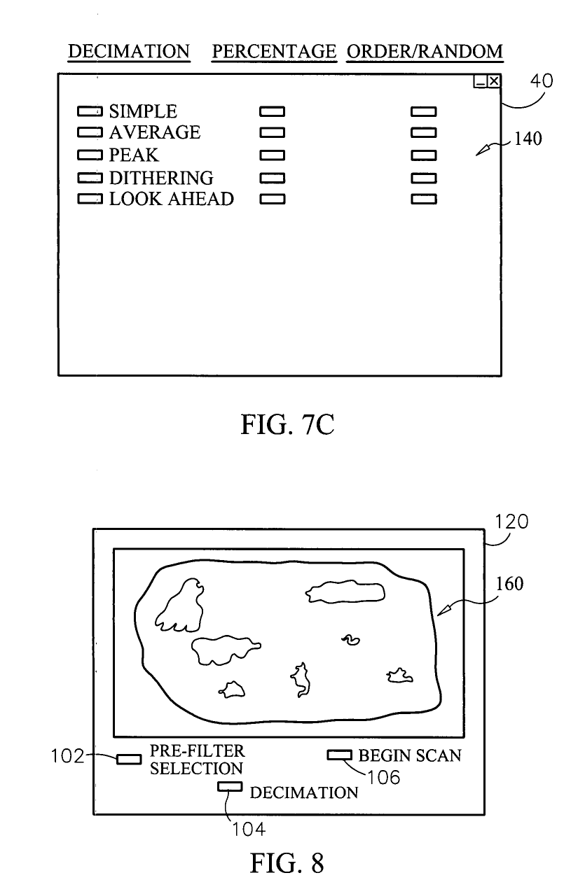

Once all selections to be made in menu 140 have been made (or none at all if the user changes his/her mind), menu 140 is closed and the user can then begin the scan by selecting on feature 106 on the user interface 120. The system then performs the scan of the object 2, optionally pre-filters the sample data generated by the scanning, applies decimation as instructed, and displays the SPM image 160 on the user interface 120, as shown in FIG. 8.

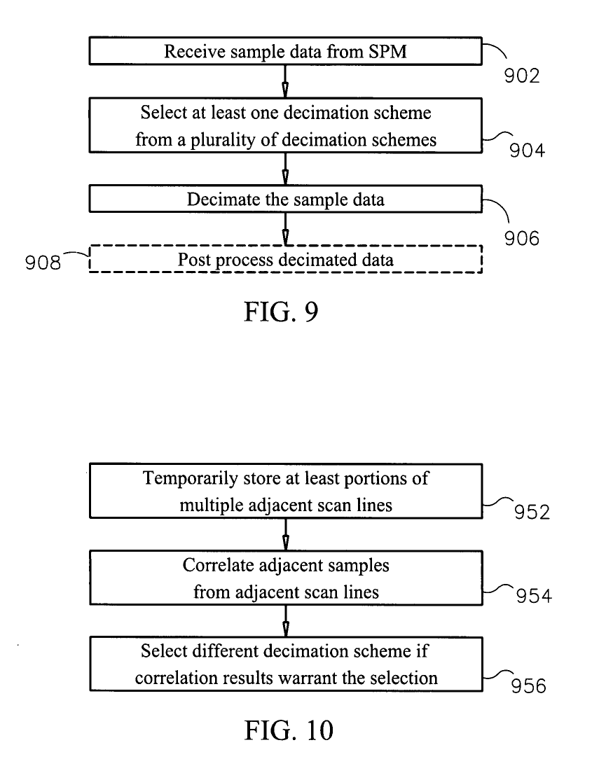

FIG. 9 illustrates events that may be carried out according to a method of decimation of SPM sample data scanned from an object according to an embodiment of the present invention. At event 902 sample data 52 is received from a scanning probe microscope, wherein the sample data includes samples 52 from sampling the object many times per each cell of a scan pattern wherein the cells correspond in size to pixels of an SPM image to be displayed form the sample data.

At event 904, at least one decimation scheme is selected from a plurality of different decimation schemes, for decimating the sample data to provide a single data value per pixel. Selection can be performed in a manner as described above.

At event 906, the system decimates that sample data using the one or more decimation schemes selected. The decimated data may optionally be post-processed at event 908, including displaying the decimated data, storing the decimated data and/or performing other post processes, examples of which were described above.

The image, if output, can be displayed on user interface 120, can be printed out on paper, or can be output in other user-usable formats.

FIG. 10 illustrates events that may be carried out according to an embodiment of a method of decimating SPM sample data scanned along scan lines on an object to be imaged. The sample data includes samples 52 from sampling the object many times per each cell of a scan pattern wherein the cells correspond in size to pixels of an SPM image to be displayed form the sample data.

At event 952, at least portions of multiple adjacent scan lines of the sample data 52 are stored prior to decimating at least a portion of the sample data 52. At event 954, adjacent samples from adjacent scan lines of the sample data are correlated.

Next, at event 956 a decimation scheme different from a previously-selected decimation scheme is selected to be applied to sample data within a pixel of the sample data when the correlating performed in event 954 provides results in which a value from one direction of comparison is different from a value from another direction of comparison by at least a predetermined value. Otherwise, the previously-selected decimation scheme is maintained for decimating the sample data for the pixel for which the correlations were performed.

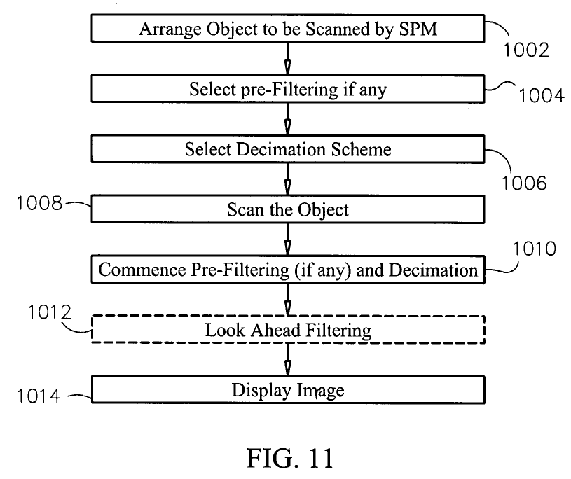

FIG. 11 illustrates events that may be carried out according to a method of providing a scanning probe microscope (SPM) image of an object according to an embodiment of the present invention. At event 1002, an object 2 is arranged to be scanned by an SPM. At event 1004, a user optionally selects (e.g., via user interface 120) any sample data pre-filtering to be performed prior to decimation. The system has a default setting that may be to perform no-pre-filtering, or to use one or more default filters to perform pre-filtering. At event 1006, the user optionally selects a decimation scheme to use for decimating the sample data. If the user does not make any selections in this event, the user has, by default, chosen the default decimation scheme that is pre-programmed into the system. The selected decimation schemes can be customized using any of the parameters described above with reference to FIG. 7C.

After events 1004 and 1006 have been completed, the SPM is initiated to scan the object 2. During scanning, pre-filtering, if any, and decimation processing are also performed in event 1010. Comparisons of sample data from multiple adjacent scans (across scan lines) are performed if look-ahead filtering was selected, event 1012. In the case where sample data to be decimated for display in a particular scan line of the image is compared with at least a previous scan line and a future scan line, where adjacent samples are compared, as described above, the system stores the sample data 52 for the line to be decimated, at least temporarily, while the next scan line of samples 52 is being scanned, so that the appropriate comparisons can be made prior to decimating. In any look-ahead filtering scheme at least some temporary data storage is performed, where at least a portion of data from a current scan line, previous scan line and/or next scan line is temporarily stored.

After decimation of the samples in a scan line, a line of pixels can be displayed from the remaining sample data after decimation of that line. With sufficient memory, displaying and decimation may be performed independently, at least to a limited extent. That is a line of data may be displayed, while a copy of that line of data can be stored in memory and used for decimation, e.g., look-ahead filtering, as described. The decimation process is repeated until samples from all scan lines (in one direction) have been decimated according to the decimation settings, and the full image of the scanned object is displayed on the user interface 120 (event 1014) for viewing by a user (FIG. 8). Alternatively, all scan lines of sample data can be decimated prior to displaying any of the image. Further alternatively or additionally, this same data can be stored to memory and/or the image can be printed out or transmitted for further use by the same or different users and/or other forms of post processing can be carried out on the data.

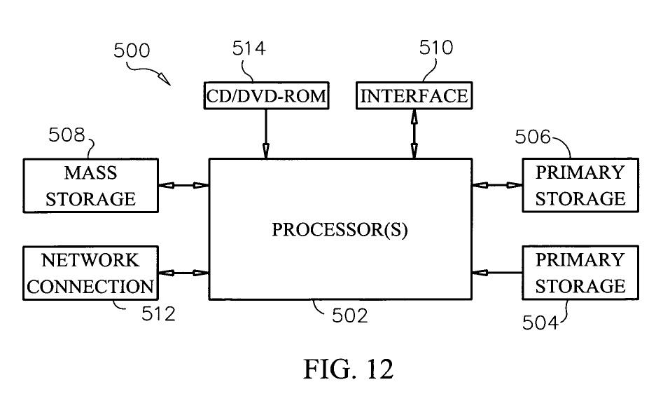

FIG. 12 illustrates a typical computer system 500 in accordance with an embodiment of the present invention. The computer system 500 may be incorporated into an SPM system, such as an AFM system 1 or other SPM system, or may be configured to receive sample data from an SPM systems, such as an AFM system 1 or other SPM system, via interface 510 and to provide settings to SPM system/AFM system 1 via user interface 120. Computer system 500 includes any number of processors 502 (also referred to as central processing units, or CPUs) that are coupled to storage devices including primary storage 506 (typically a random access memory, or RAM), primary storage 504 (typically a read only memory, or ROM). Primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 is also coupled bi-directionally to CPU 502 and provides additional data storage capacity and may include any of the computer-readable media described above. Mass storage device 508 may be used to store programs, such as decimation algorithms/schemes, programs for operating user interface 120, data and the like and is typically a secondary storage medium such as a hard disk that is slower than primary storage. It will be appreciated that the information from primary storage 506, may, in appropriate cases, be stored on mass storage device 508 as virtual memory to free up space on primary storage 506, thereby increasing the effective memory of primary storage 506. A specific mass storage device such as a CD-ROM or DVD-ROM 514 may also pass data uni-directionally to the CPU.

CPU 502 is also coupled to an interface 510 that includes one or more input/output devices such as video monitors, user interface 120, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to a computer or telecommunications network using a network connection as shown generally at 512. With such a network connection, it is contemplated that the CPU might receive information from the network, or might output information to the network in the course of performing the above-described method steps. The above-described devices and materials are known in the computer hardware and software arts.

The hardware elements described above may implement the instructions of multiple software modules for performing the operations of this invention. For example, instructions for pre-filtering and decimation methods and settings may be stored on mass storage device 508 or 514 and executed on CPU 502 in conjunction with primary memory 506.

While the present invention has been described with reference to the specific embodiments thereof, it should be understood that various changes may be made and equivalents may be substituted without departing from the scope of the invention defined by the claims.

We claim:

1. A method of decimating data from a scanning probe microscope (SPM), said method comprising:
receiving sample data from a scanning probe microscope wherein said sample data comprises data sampled many times per pixel of an SPM image that can be generated from said sample data;
selecting, from a plurality of different decimation schemes, at least one decimation scheme for decimating said sample data to provide a single data value per pixel; and
decimating said sample data using said at least one selected decimation scheme.

2. The method of claim 1, further comprising post processing said sample data after said decimating.

3. The method of claim 2, wherein said post processing comprises displaying said SPM image from said sample data after said decimating.

4. The method of claim 1, further comprising storing all of said received sample data.

5. The method of claim 1, wherein said plurality of different decimation schemes comprises at least two of: a simple decimation scheme, an averaging decimation scheme, an acquisition clock dithering decimation scheme, and a peak decimation scheme.

6. The method of claim 1, further comprising pre-filtering said sample data prior to said decimating.

7. The method of claim 1, additionally comprising look-ahead filtering of said sample data prior to said decimating of at least a portion of said sample data.

8. The method of claim 6, wherein said look-ahead filtering comprises delaying said decimating of at least a portion of a scan line of said sample data.

9. The method of claim 6, wherein said look-ahead filtering comprises correlating adjacent samples of said sample data.

10. The method of claim 6, wherein said look-ahead filtering comprises correlating adjacent lines of said sample data.

11. The method of claim 6, further comprising changing a decimation scheme to be applied to samples within a pixel when said look-ahead filtering provides results in which a value in one direction of comparison is different from a value in another direction of comparison by at least a predetermined value.

12. The method of claim 1, wherein said decimating processes samples of said sample data according to a non-integer selection interval.

13. A user interface for facilitating decimating sample data from a scanning probe microscope (SPM), said interface comprising:
a display; and
a feature on said display for use in selecting at least one decimation scheme from a plurality of different decimation schemes, said at least one selected decimation scheme to be applied to said sample data from said scanning probe microscope (SPM).

14. The user interface of claim 13, further comprising a feature on said display for use in selecting at least one pre-filtering scheme from a plurality of pre-filtering schemes to pre-filter said sample data prior to applying said at least one decimation scheme.

15. The user interface of claim 13, wherein said feature for use in selecting at least one decimation scheme allows a user to select multiple different decimation schemes to be applied to multiple portions of said sample data, respectively.

16. The user interface of claim 15, wherein said feature for use in selecting said at least one decimation scheme allows a user to assign percentages of said sample data, per pixel, to which each of said selected multiple different decimation schemes is applied.

17. The user interface of claim 15, wherein said feature for use in selecting said at least one decimation scheme allows a user to assign an order in which said selected decimation schemes are applied to said sample data per pixel.

18. The user interface of claim 13, further comprising a feature for use in selecting look-ahead filtering to be applied to at least a portion of said sample data.

19. The method of claim 18, wherein:
said look-ahead filtering comprises correlating adjacent samples of said sample data, and
a decimation scheme selected to be applied to sample data within a pixel of said sample data is automatically changed to a different decimation scheme when said look-ahead filtering provides results in which a value from one direction of comparison is different from a value from another direction of comparison by at least a predetermined value.

20. A scanning probe microscope (SPM) imaging system comprising:
a scanning probe microscope (SPM);
a user interface including a display for displaying an image produced from sample data received from said SPM;
a feature displayed on said display for use in selection of at least one decimation scheme from a plurality of decimation schemes included in said system; and
a processor for executing said at least one decimation scheme to decimate said sample data.

21. The system of claim 20, further comprising a selectable look-ahead filter, wherein execution of said look-ahead filter includes correlating adjacent samples of said sample data, and wherein a decimation scheme selected to be applied to sample data within a pixel of said sample data is automatically changed to a different decimation scheme when said look-ahead filtering provides results in which a value from one direction of comparison is different from a value from another direction of comparison by at least a predetermined value.

22. The system of claim 20, further comprising a feature for use in selecting at least one pre-filtering scheme from a plurality of pre-filtering schemes for pre-filtering said sample data prior to decimation of said sample data.

23. A computer readable medium carrying one or more sequences of instructions for decimating sample data scanned along scan lines from a surface of an object, wherein said sample data comprises data sampled many times per pixel of an image that can be generated from said sample data, wherein execution of the one or more sequences of instructions by one or more processors causes the one or more processors to perform a process comprising:
at least temporarily storing multiple adjacent samples of said sample data prior to decimating at least a portion of said sample data;
correlating adjacent samples of said sample data; and
selecting a decimation scheme different from a decimation scheme previously selected to be applied to sample data within a pixel pertaining to said image that can be generated, when said correlating provides results in which a value from one direction of comparison is different from a value from another direction of comparison by at least a predetermined value, but otherwise maintaining said previously selected decimation scheme for decimating said sample data pertaining to said pixel.

24. The computer readable medium of claim 23, wherein said previously selected decimation scheme is automatically selected by default.
